(19) United States
(12) Patent Application Publication
(10) Pub. No.: US 2003/0190388 A1
(43) Pub. Date: Oct. 9, 2003

(54) Accelerated wine making kit and method

(76) Inventor: Rick A. Morris, Calgary (CA)

Correspondence Address: Donald W. Meeker, Patent Agent, 924 East Ocean Front, # E, Newport Beach, CA, 92661, US

(21) Appl. No.: 10/116,152

(22) Filed: Apr. 4, 2002

(51) Int. Cl. C12C 11/00

(52) U.S. Cl. 426/11

(57) ABSTRACT

A method of adding to wine must large quantities of yeast combined with yeast nutrients, minerals, vitamin B complex, and magnesium sulphate to ferment the wine must to wine in little as four days in a closed container between 20-30° C. Adding quantities of potassium metabisulfite and potassium sorbate sufficient to release CO₂ from the fermented wine and stop the fermation process. Adding Sparkolloid clearing and filtering aid in sufficient quantity to clear the fermented wine in two days in a cool environment. A kit for carrying out the method.

### DESCRIPTION

### BACKGROUND OF THE INVENTION

1. Field of the Invention

The present invention relates to wine making and in particular to a wine making kit and method for shortening the time period normally associated with the making of wine to produce a wine of equal or better quality than the other wine making methods in one fourth the time: an accelerated wine making method and kit.

2. Description of the Prior Art

Wine making is an art enjoyed by many individuals with a satisfying product to enjoy at the end of the process. There can be creativity involved in producing a variety of flavors and bouquets by varying and combining the grapes or wine must as well as the additional ingredients used.

In locations where alcoholic beverages are highly taxed or import taxes are high, it is often a necessity to make one's own wine because of the prohibitive costs of buying it.

Standard wine producing kits and methods normally produce drinkable wine in approximately four weeks. The fermentation process using standard quantities of standard ingredients takes that long to transform the sugar in the grapes or wine must into alcohol in the desired quantity to produce wine with the desired taste and salubrious effect.

Four weeks is a long time to wait for a glass of wine.

### SUMMARY OF THE INVENTION

An object of the present invention is to provide an accelerated wine making kit and method which produces a wine in as little as seven days of equal or better quality than wine making kits and methods that require twenty-eight days to make wine.

Another object of the present invention is to increase the speed of fermentation of the wine by increasing the amount of yeast used and by adding a special combination of yeast nutrients, minerals, and vitamin B complex.

One more object of the present invention is to increase the speed of clearing the wine by using Sparkolloid, a clearing agent and filtering aid, as a rapid clearing agent.

In brief an accelerated wine making kit and method comprises adding to wine must a quantity (at least two to three times the usual amount used in wine making) of yeast sufficient to ferment the wine must within as little as four days, the yeast being combined with yeast nutrients, minerals, vitamin B complex, and magnesium sulphate for fermenting the wine must in a closed fermenting container for maintaining the fermenting wine at a temperature between 20-30° C., preferably between 25-30° C., and always below 35° C.

After day two the fermenting wine must is stirred with a means for stirring the fermenting wine, such as a long-handled spoon, when the fermentation process slows.

After as little as four days added to the fermented wine must, now wine, quantities of potassium metabisulfite and potassium sorbate sufficient to release CO₂ from the fermented wine and to stop the fermentation process. A quantity of a clearing agent and filtering aid, preferably Sparkolloid, is added to the fermented wine in sufficient quantity to clear the wine in a two-day clearing process in a clearing container capable of cooling the wine.

When clear, the wine is poured in the wine bottles and corked.

The present invention has a primary advantage in that it accelerates the wine making process and produces wine of equal or superior quality to other wine making methods in as little as seven days, one-fourth the time it takes for other wine making methods.

Another advantage of the present invention is that all of the flavor, aroma, and depth of character of the grape varietal used is retained throughout this process.

A related advantage of the present invention is that the white wines will be fruity and well balanced using this process.

Another related advantage of the present invention is that the red wines exhibit a wonderful bouquet, color, and richness.

### BEST MODE FOR CARRYING OUT THE INVENTION

An accelerated wine making kit for making finished wine in as little as seven days comprises a quantity of wine must, a quantity of yeast (at least two to three times the amount normally used in wine making: normally 5 g. per 23 liters) sufficient to ferment the quantity of wine must within as little as four days, the yeast being combined with yeast nutrients (ammonium and diammonium phosphate), minerals, vitamin B complex, and magnesium sulphate for fermenting the wine must in a closed fermenting container for maintaining the fermenting wine at a temperature between 20-30° C., preferably between 25-30° C., and always below 35° C., quantities of potassium metabisulfite and potassium sorbate sufficient to release CO₂ from the fermented wine and stop the fermentation process, and a quantity of a clearing agent and filtering aid, preferably Sparkolloid, in sufficient quantity to clear the wine in a two-day clearing process in a clearing container capable of cooling the wine during the two day clearing process.

An accelerated wine making method for making finished wine in as little as seven days comprises:

the first step of adding a quantity of wine must to a sterilized fermenting container at a temperature of 21-24° C.;

the second step of adding to the wine must and stirring vigorously a quantity (at least two to three times the normal amount used in wine making) of yeast sufficient to ferment the quantity of wine must within as little as four days, the yeast being combined with yeast nutrients, minerals, vitamin B complex, and magnesium sulphate and fermenting the wine must in a closed fermenting container for maintaining the fermenting wine at a temperature between 20-30° C., preferably between 25-30° C., and always below 35° C.;

a third step of stirring the fermenting wine must with a means for stirring, such as a long-handled spoon, when the fermentation process slows;

a fourth step of pouring the fermented wine into a clearing container, filtering out the sediment, and adding quantities of potassium metabisulfite and potassium sorbate sufficient to release CO₂ from the fermented wine and to stop the fermentation process, and shaking vigorously to remove the CO₂; (repeating this step five to six times as necessary to remove all the CO₂)

a fifth step of adding a quantity of a clearing agent and filtering aid, preferably Sparkolloid, in sufficient quantity, shaking vigorously, to clear the wine in a two-day clearing process in a clearing container capable of cooling the wine during the two day clearing process.

It is understood that the preceding description is given merely by way of illustration and not in limitation of the invention and that various modifications may be made thereto without departing from the spirit of the invention as claimed.

What is claimed is:

1. An accelerated wine making kit for making finished wine in as little as seven days, the kit comprising:
a quantity of wine must;
a quantity of yeast sufficient to ferment the quantity of wine must within as little as four days, the yeast being combined with yeast nutrients, minerals, vitamin B complex, and magnesium sulphate for fermenting the wine must in a closed fermenting container for maintaining the fermenting wine at a temperature between 20-30° C., preferably between 25-30° C., and always below 35° C.;
quantities of potassium metabisulfite and potassium sorbate sufficient to release CO₂ from the fermented wine and stop the fermentation process;
a quantity of a clearing agent and filtering aid in sufficient quantity to clear the wine in a two-day clearing process in a clearing container capable of cooling the wine during the two day clearing process.

2. The wine making kit of claim 1 wherein the clearing and filtering aid is Sparkolloid.

3. The wine making kit of claim 1 wherein the quantity of yeast is at least two to three times the amount normally used in making wine for the quantity of wine must.

4. An accelerated wine making method for making finished wine in as little as seven days, the method comprising:
the first step of adding a quantity of wine must to a sterilized fermenting container;
the second step of adding to the wine must a quantity of yeast sufficient to ferment the quantity of wine must within as little as four days, the yeast being combined with yeast nutrients, minerals, vitamin B complex, and magnesium sulphate, and fermenting the wine must in a closed fermenting container for maintaining the fermenting wine at a temperature between 20-30° C., preferably between 25-30° C., and always below 35° C.;
a third step of stirring the fermenting wine must with a means for stirring when the fermentation process slows;
a fourth step of adding quantities of potassium metabisulfite and potassium sorbate sufficient to release CO₂ from the fermented wine and to stop the fermentation process;
a fifth step of adding a quantity of a clearing agent and filtering aid in sufficient quantity to clear the wine in a two-day clearing process in a clearing container capable of cooling the wine during the two day clearing.

5. The wine making method of claim 4 wherein the clearing and filtering aid is Sparkolloid.

6. The wine making method of claim 4 wherein the quantity of yeast is at least two to three times the amount normally used in making wine for the quantity of wine must.
